(19) United States
(12) Patent Application Publication
(10) Pub. No.: US 2006/0207139 A1
(43) Pub. Date: Sep. 21, 2006

(54) Flexible display

(75) Inventors: Emmanuel Deflin, Grenoble (FR); Emeric Mourot, Grenoble (FR); Michel Remy, Saint Martin D'Heres (FR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 11/438,780

(22) Filed: May 22, 2006

Related U.S. Application Data
(63) Continuation of application No. 10/553,634, filed on Oct. 19, 2005.

(30) Foreign Application Priority Data
Apr. 29, 2003 (FR) 03 05238

(51) Int. Cl. G09F 13/22

(52) U.S. Cl. 40/544

(57) ABSTRACT

The invention relates to a flexible display, comprising a flexible support, discrete light sources, arranged in a dispersed manner on the flexible support, means for controlling power supply for the light sources, means, incorporated in the flexible support, for transmission between the means for control of the power supply and the discrete light sources, and control and power signals for the discrete light sources. The above further comprises a diffuser element, covering the light sources, such that the light originating from two adjacent discrete light sources produces an essentially continuous light display on a face of the diffuser element opposite the light sources.

### CROSS-REFERENCE TO RELATED APPLICATIONS

This application is a continuation of U.S. patent application Ser. No. 10/553,634 filed Oct. 19, 2005, which is the U.S. national phase of the International Patent Application No. PCT/FR2004/000936 filed Apr. 15, 2004, which claims the benefit of French Application No. 03 05238 filed Apr. 29, 2003, the entire content of which is incorporated herein by reference.

### BACKGROUND OF THE INVENTION

The present invention relates to the field of flexible displays and more particularly to flexible displays that can be integrated into textile supports, for example garments. These displays are therefore said to be pliable. The applications relate, among others to the advertising, safety and leisure sectors, or to special events. They relate in particular to the dissemination of visual information on the clothing worn by a person, enabling this information to be perceived by those people located in the immediate vicinity of the display.

The current technologies used in flexible displays have major drawbacks, which prevent or greatly impede their integration into textile supports. These drawbacks are, for example, excessively high rigidity of the display, bulkiness, and power consumption or weight that are incompatible with the desired type of application, or else the impossibility of customizing the esthetic character of the screen according to the target textile support.

### SUMMARY OF THE INVENTION

It is an object of the present invention to propose a flexible display that is less affected by the abovementioned limitations.

Thus, according to a first aspect, the invention proposes a flexible display comprising:

a flexible support;

a plurality of discrete light sources, fastened to the flexible support so as to be spaced apart thereon;

light-source supply/control means;

means, included in the flexible support, for transmitting, between the supply/control means and the discrete light sources, supply/control signals for the discrete light sources; and

a diffusing element that covers the light sources so as to diffuse the light coming from two adjacent discrete light sources in order to produce a substantially continuous luminous display on one face of the diffusing element opposite the light sources.

The diffusing element makes it possible to increase the visibility of each discrete light source, while reducing its emission area. One of the advantages of this display is therefore that it allows production of a large and very legible display to be produced by using a limited number of light sources per unit area. This is because it allows the light sources to be spaced apart. This provides a very flexible screen, the joins between the light spots being formed by the diffusing element. Among the advantages of the display according to the invention are also easy production and limited operating power, this being proportional to the number of light sources.

In an advantageous embodiment, the light sources are fastened to the flexible support in a matrix arrangement.

The display may furthermore include a covering element which covers the face of the diffusing element while letting light pass through it. This covering element provides a specific esthetic cover and thus makes it easier to integrate it into a textile support.

Advantageously, the light sources can be individually controlled in order to emit light. The flexible support may be a polymer film or substrate. For example, it is made of the material known under the brand name “Kapton”. It may also consist of a ribbon of optical fibers, as presented in patent application FR 01/02623. In a preferred embodiment, the flexible support is made of fabric and comprises woven yarns, including electrically conducting wires used to transmit the supply/control signals. Furthermore, the discrete light-emitting sources can then be soldered to the conducting wires.

According to a second aspect, the invention proposes a textile structure that includes a display according to the invention.

Advantageously, this textile structure, for example a garment or rucksack, has a pocket provided with a lower piece and with an upper piece that let light pass through it, at least the flexible support and the plurality of discrete light sources of the display being held in place between said lower and upper pieces.

The pocket may include means for extracting the display. This feature makes it possible to remove the display, especially for the purpose of washing the textile structure without any risk to the display, or to be able to transfer the display from one textile structure to another.

The upper piece of the pocket may incorporate the diffusing element of the display. It may also include, on the surface, a covering element, which covers the face of the diffusing element.

### BRIEF DESCRIPTION OF THE DRAWINGS

Other features and advantages of the invention will become more apparent on reading the description that follows. This is purely illustrative and must be read in conjunction with the appended drawings in which:

FIG. 1 shows various components of a flexible display in one embodiment of the invention;

FIG. 2 shows one embodiment of a flexible support according to the invention;

FIG. 3a shows a display presented by a flexible support according to the invention;

FIG. 3b shows a display presented by the flexible support of FIG. 3a and covered by the diffusing element;

FIG. 3c shows a display presented by the display shown in FIG. 3b and covered with a covering element;

FIG. 4 shows a cross-sectional view of a first embodiment of a display according to the invention;

FIG. 5 shows a cross-sectional view of a second embodiment of a display according to the invention;

FIG. 6 shows a cross-sectional view of a third embodiment of a display according to the invention; and

FIG. 7 shows one embodiment of a textile structure according to the invention.

### DESCRIPTION OF PREFERRED EMBODIMENTS

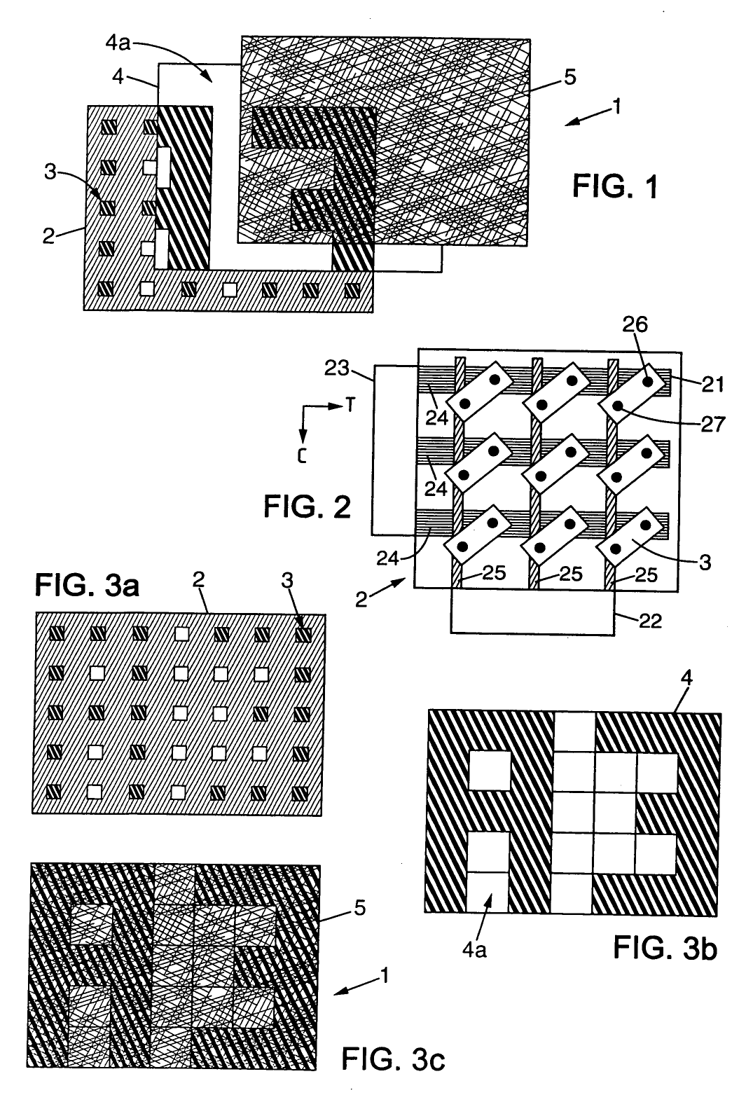

FIG. 1 shows various components of a flexible display 1 in one embodiment of the invention. These various components are shown nonsuperposed so as to be able to demonstrate the contribution of each of these components taken individually. This flexible display 1 includes a flexible support 2. A matrix of 7×5 spaced-apart discrete light sources 3 is fastened to the flexible support 2. This support includes a connection system intended for supplying and controlling the light sources 3 from supply/control means which will be described later. The flexible display 1 furthermore includes a diffusing element 4 that covers the light sources 3. This diffusing element 4 increases the visibility of each light source, while reducing its emission area beyond the emission area of the light sources. It provides an artificial continuous join between two adjacent light sources lit on one of its faces 4a, which is on the opposite side from the light sources. In the figures, the light sources shown hatched are turned on, while those shown blank are turned off. The flexible display 1 furthermore includes a covering element 5, in order to provide a cover specific to the display 1, by means of a variety of textile materials, colors, and weaving or knitting patterns. This covering element 5 furthermore provides the display 1 with novel physical properties, for example sealing or impact strength properties.

It should be noted that the diffusing element 4 could itself incorporate the features presented here by the covering element 5.

In the particular embodiment in question, the flexible support 2 is, for example, made of woven fabric. It may be of the type described above. The light sources 3 are LEDs (light-emitting diodes) in SMC (surface mount component) technology directly addressable on and soldered to the support 2. The diffusing element 4 is flexible and may be a foam, a woven fabric or a knitted structure. The diffusing element 4 and the covering element 5 are for example assembled by lamination.

FIG. 2 shows a flexible support 2 made of woven fabric produced from woven yarns. Included among these yarns are electrically conducting woven wires 21 blended with other textile yarns. The support 2 is for example woven in a plain weave, with a sufficiently loose (open) mesh structure to be able to let the conducting wires 21 be visible in segments. The fineness of the wires employed is high enough to give the fabric good surface finish (roughness less than 0.15 mm) sufficient to be able to act as a support during the operation of soldering the wires to conventional printed circuits using soldering tools.

The textile yarns are for example insulating from the electrical standpoint and are resistant to physical stresses, especially the temperatures imposed by the soldering. For example, they are made of cotton, polyester or polyamide.

The conducting wires 21 may be made of copper, tinned copper, silvered copper or gilded copper and are sheathed in a polymer (e.g. polyester) resin that electrically isolates them from one another. These conducting wires are woven in a precise weaving pattern so as to be able, by being grouped together, to constitute conducting tracks each transporting a signal from the supply/control modules 22 and 23 to the LEDs 3 placed on the tracks.

The conducting tracks each comprise one or more substantially parallel conducting wires, so as to distribute the energy transported.

The weaving design used, shown in FIG. 2, defines an arrangement of three tracks 24 along a first, weft direction T and three tracks 25 along a warp direction C.

The directly addressable SMC-type LEDs are placed at the intersection between the tracks 24 that run along the weft direction and the tracks 25 that run along the warp direction. These LEDs 3 have a first control electrode 26 soldered to a track 24 and a second control electrode 27 soldered to a track 25. This soldering is carried out in a very short space of time and at a temperature high enough to be able very quickly to strip off the protective insulation on the electrical wires, which insulation melts under the heat, and to solder these wires, without however damaging the rest of the fabric. Moreover, at the intersections between the tracks 24 and 25 along the weft and warp directions, no electrical contact is made, since the wires 21 constituting the tracks, although being in contact through the weaving operation, are electrically isolated from one another by the polymer sheath.

The wires 21 may be soldered in the same manner to rigid printed circuits contained in control modules 22 and 23. These wires may also be connected to “insulation-displacement” connectors located in these modules.

Finally, with a view to mechanically protecting the display, a textile embellishment may be applied, by embedding the LEDs 3 in a flexible resin, for example by spraying or coating with a polymer, for example a silicon polymer. Once the resin has cured, this protective layer will contain good flexibility and keep the LEDs 3 in place on the fabric, while guaranteeing that the assembly is sealed.

The two modules 22 and 23 are for example electronic multiplexing control modules. They control the lighting of the LEDs 3 and send directly to them, via the conducting wires 21, an electrical current that depends on the display brightness desired for each of them.

The module 22 controls, for example the warp tracks 25. It is connected to one of the ends of all of the warp tracks, and therefore lies in the weft direction along one of the sides of the support 2.

The module 23 controls for example the weft tracks 24. It is connected to one of the ends of all of the weft tracks, and therefore lies in the warp direction along one of the sides of the support 2.

The LEDs 3 are driven, for example according to a time scan principle. For example, the control module 23 connects the weft tracks 24 one after another to a supply terminal. This time scan is not perceptible to the human eye. For a weft track 24 addressed by the module 23, an LED 3 is actually supplied and radiates if it is connected to the other supply terminal via a warp track 25 by the module 22. This selection LED by LED for the module 22 is obtained for example using switches based at the input of each warp track 25.

Other embodiments of the support furnished with light sources and with corresponding supply/control and signal-transmission means may also be envisioned.

FIG. 3a shows the display presented by a flexible support 2 according to the invention to which the LEDs 3 are fixed. The LEDs 3 have been selected so as to display pattern “A3”.

FIG. 3b shows the display presented by the face 4a of the diffusing element 4 that covers the furnished flexible support of FIG. 3a.

FIG. 3c shows the display presented by the covering element 5 that covers the display shown in FIG. 3b.

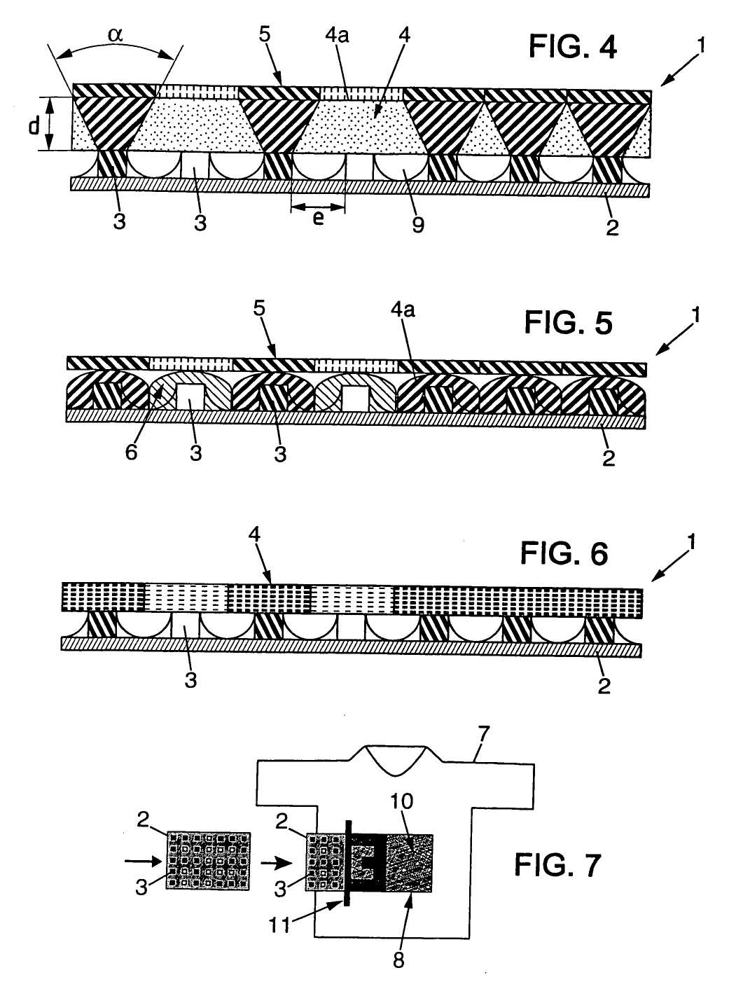

FIGS. 4 to 6 show various possible embodiments of the display according to the invention, according to the type of diffusing element 4 chosen. The figures correspond to a cross section through the display 1 along the last row at the bottom of the display 1 shown in FIG. 1 and FIG. 3c.

The diffusing element 4 shown in FIG. 4 allows the covering element 5 to be positioned at the desired distance (by varying its thickness) from the LEDs 3. The area of the light spot or pixel visible from the display 1 according to the invention in question will therefore depend on the emission cone angle α of the LED, on the thickness d of the diffusing element 4 and on the spacing e between the LEDs. This diffusing element 4 may be made of foam-type material.

The LEDs 3 are embedded in a flexible resin 9, which allows the display 1 to withstand the mechanical stresses due to bending.

In the embodiment of the display 1 shown in FIG. 5, the light emitted by the LEDs 3 is diffused and scattered within a diffusing element consisting of transparent encapsulating cells 6. The light is then projected onto the covering element 5. It may be advantageous for these cells 6 not to be fastened together and the covering element 5 not to be fastened to the cells 6, thereby ensuring that the display has maximum flexibility.

In the embodiment of the display 1 shown in FIG. 6, the light emitted by the LEDs 3 is diffused directly into a diffusing element 4, which also provides the function of a covering element, made of a material exhibiting specific light-conduction characteristics, either through the nature of the material employed (e.g. polyester, polyamide, etc.) or through, or in combination with, its construction (woven fabric, knitted structure, nonwoven fabric, foam, etc.).

One of the main advantages of a display according to the invention is the possibility of adapting the elements that make up the display according to the desired effect or according to imposed constraints.

This is because, in particular depending on the choice of the diffusing element 4, it is possible to generate larger pixels or smaller pixels on the surface of the display 1, and therefore to use more or fewer light sources, for the same image definition. It is thus possible to adapt the flexibility of the display, which in particular depends on the number of light sources, according to the imposed flexibility constraints.

The flexible support, including the light sources, the diffusing element and, optionally, the covering element may be assembled by adhesive bonding.

In another embodiment, the flexible support may be adhesively bonded to the diffusing element, the covering element being simply placed on top of the diffusing element so as to allow one to slide over the other. This sliding effect has the advantage of reducing the resistance of the entire display to bending.

In another embodiment, the diffusing element and the covering element may be assembled by adhesive bonding or stitching, and then these may be placed on the support furnished with light sources, again in this case with the possibility of sliding.

This assembly operation must guarantee that the various components of the display, namely the support furnished with light sources, the diffusing element and possibly the covering element, are held together in perfect contact in order to be able to provide uniform size and visibility of the pixels on the surface of the screen.

Another aspect of the invention relates to a textile structure that includes a display according to the first aspect of the invention. The display may be assembled, definitively or otherwise, to the rest of the textile structure in various ways, namely by means of conventional haberdashery systems such as zips, Velcro strips, press-studs, or by stitching. In another embodiment, the display, or certain constituent elements of the display (for example the support furnished with light sources, or the display covered with the diffusing element and/or with the covering element), may also be inserted into a suitable pocket via an opening. The function of this pocket may be simply to provide retention with transparency, or to furthermore include, as will be explained in detail later, the diffusing element and/or the covering element. In particular this pocket allows the display to be removed from the textile structure.

As indicated above, the diffusing element and/or the covering element may be made up in the textile structure itself For example, they may form part of a retaining pocket, as mentioned above, and as shown in FIG. 7. A shirt 7 has a pocket 8. An upper piece 10 of the pocket 8, of substantially rectangular shape, consists of a diffusing element and a covering element, for example stitched together, the covering element being placed so as to cover that face of the diffusing element on the opposite side from the LEDs. The periphery of this upper piece is stitched, apart from one of the sides, to the rest of the textile structure, thus defining, on the rest of the textile structure, a lower piece of the pocket and a housing between the lower piece and the upper piece 10, said housing having dimensions suitable for housing therein a flexible support 2 furnished with LEDs 3 similar to that shown in FIG. 3a. This support may be inserted as shown in FIG. 7. The pocket is provided with a closure system 11, for example a zip.

The covering element on the upper piece 10 may be adapted so as not to show a visible demarcation with respect to the rest of the surface of the shirt 7 when the display is turned on.

The different possible ways of assembling the various components of the screen presented in the case of the display according to the invention are of course applicable in the case of the textile structure according to the invention.

Thus, a display according to the invention has many advantages, in particular in terms of flexibility, thanks to the relative freedom one has as regards the number of light sources to be used, the display quality owing to pixellation rendered continuous thanks to the diffusing element, its size and weight, and its simplicity of production. Thus, a communicating textile structure can be produced, which guarantees both high-quality display and wear comfort.

What is claimed is:

1. A flexible display comprising:
a flexible support;
a plurality of discrete light sources, fastened to the flexible support so as to be spaced apart thereon;
means, included in the flexible support, for transmitting, between the supply/control means and the discrete light sources, supply/control signals for the discrete light sources; and
a diffusing element that covers the light sources so as to diffuse the light coming from two adjacent discrete light sources in order to produce a substantially continuous luminous display on one face of the diffusing element, this face being on the opposite side from the light sources.

2. The display as claimed in claim 1, in which the light sources are fastened to the flexible support in a matrix arrangement.

3. The display as claimed in claim 1, which includes a covering element, which covers said face of the diffusing element while letting light pass through it.

4. The display as claimed in claim 1, in which the light sources can be individually controlled in order to emit light.

5. The display as claimed in claim 1, in which:
the flexible support is a support made of a fabric comprising woven yarns that include electrically conducting wires;
the supply/control signal transmission means comprise said electrically conducting wires; and
the discrete light-emitting sources are soldered to the conducting wires.

6. The display as claimed in claim 1, in which the light sources comprise light-emitting diodes soldered to the flexible support.

7. The display as claimed in claim 6, in which the light-emitting diodes are embedded in a flexible resin.

8. A textile structure that includes a flexible display, said flexible display comprising:
a flexible support;
a plurality of discrete light sources, fastened to the flexible support so as to be spaced apart thereon;
means, included in the flexible support, for transmitting, between the supply/control means and the discrete light sources, supply/control signals for the discrete light sources; and
a diffusing element that covers the light sources so as to diffuse the light coming from two adjacent discrete light sources in order to produce a substantially continuous luminous display on one face of the diffusing element, this face being on the opposite side from the light sources.

9. The textile structure as claimed in claim 8, which has a pocket provided with a lower piece and with an upper piece that let light pass through it, at least the flexible support and the plurality of discrete light sources of the display being held in place between said lower and upper pieces.

10. The textile structure as claimed in claim 8, in which the pocket includes means for extracting the display.

11. The textile structure as claimed in claim 9, in which the upper piece incorporates the diffusing element of the display.

12. The textile structure as claimed in claim 9, in which the upper piece includes, on the surface, a covering element that covers said face of the diffusing element.

13. The display as claimed in claim 1, comprising light-source supply/control means.

14. A textile structure as claimed in claim 8, wherein the flexible display comprises light-source supply/control means.

15. The textile structure as claimed in claim 8, in which the light sources are fastened to the flexible support in a matrix arrangement.

16. The textile structure as claimed in claim 8, which includes a covering element, which covers said face of the diffusing element while letting light pass through it.

17. The textile structure as claimed in claim 8, in which the light sources can be individually controlled in order to emit light.

18. The textile structure as claimed in claim 8, in which:
the flexible support is a support made of a fabric comprising woven yarns that include electrically conducting wires;
the supply/control signal transmission means comprise said electrically conducting wires; and
the discrete light-emitting sources are soldered to the conducting wires.

19. The textile structure as claimed in claim 8, in which the light sources comprise light-emitting diodes soldered to the flexible support.

20. The textile structure as claimed in claim 19, in which the light-emitting diodes are embedded in a flexible resin.

21. A process for manufacturing a flexible display, comprising the steps consisting in:
producing a flexible support that incorporates electrically conducting wires;
connecting diodes with electrically conducting wires of the flexible support;
and covering the diodes with a diffusing element.

22. The process as claimed in claim 21, in which the diodes are connected to electrically conducting wires of the flexible support by soldering.

23. The process as claimed in claim 21, in which the flexible support is manufactured by weaving electrically conducting wires with non-conducting yarns.

24. The process as claimed in claim 23, in which the weaving in carried out in such a way that conducting wires are left exposed in segments.

25. The process as claimed in claim 21, in which the diodes are places at the intersection of tracks, each track comprising a conducting wire or several approximately parallel conducting wires.

26. The process as claimed in claim 21, which includes a step of embedding the diodes in a flexible resin.
